(19) United States
(12) Patent Application Publication
(10) Pub. No.: US 2012/0127830 A1
(43) Pub. Date: May 24, 2012

(54) DOWNHOLE IMAGING SYSTEM AND RELATED METHODS OF USE

(75) Inventor: Praful C. Desai, Kingwood, TX (US)

(73) Assignee: SMITH INTERNATIONAL, INC., Houston, TX (US)

(21) Appl. No.: 12/952,999

(22) Filed: Nov. 23, 2010

(51) Int. Cl. G01V 1/46

(52) U.S. Cl. 367/86

(57) ABSTRACT

A downhole imaging system includes a downhole imaging tool, a surface workstation, and a real-time data feed configured to connect between the downhole imaging tool and the surface workstation.

### BACKGROUND

1. Field of the Disclosure

Embodiments disclosed herein relate generally to downhole tools. More particularly, embodiments disclosed herein relate to downhole imaging systems and methods of locating objects in a wellbore.

2. Background Art

A wellbore may be drilled in the earth for various purposes. For example, wellbores may be drilled to extract hydrocarbons, geothermal energy, or water. After a wellbore is drilled, the wellbore is typically lined with casing to preserve the shape of the wellbore and to provide a sealed conduit for fluid transportation.

Various situations may arise in downhole in which an idea of what a particular section of the wellbore or casing looks like may be beneficial to an operator at the surface. For example, a bit may break, a pipe may twist, or a tool may go missing in the wellbore, which may block the wellbore and cause rig operations to be shut down. In this event, a fishing operation may be commenced in an attempt to remove the lost or damaged objected lodged in the wellbore. However, knowledge of a precise location, shape, and orientation of the obstruction may be beneficial to the operator prior to commencing the fishing operation. In a further unrelated example, in a sidetracking operation, during which a window (also known as a “rat hole”) is milled through a wall of the casing to extend a lateral wellbore therefrom, an initial image of the shape and/or precise location of the milled window in the casing may be beneficial to the operator. Still further, examination of a formation borehole wall (uncased bore) may be beneficial to determine particular formation characteristics at a depth or orientation, for example, fractures, voids, and other formation anomalies.

Generally, in above described situations, the current practice is to run an impression block with a lead (Pb) bottom, which when pressed against the undesirable object lodged in the borehole, creates facial impression of the object. This provides only the frontal face information of the object and no other information. Additionally, it requires a separate trip. In other situations a downhole camera may be run in the hole to visually observe the lodged object or casing anomalies. The drawback of downhole camera is that it requires clear fluid in the wellbore and will not function in a turbid medium.

Accordingly, there exists a need for a system and method for providing an operator a downhole image at a precise location of the wellbore in any medium including a turbid medium.

### SUMMARY OF THE DISCLOSURE

In one aspect, embodiments disclosed herein relate to a downhole imaging system including a downhole imaging tool, a surface workstation, and a real-time data feed configured to connect between the downhole imaging tool and the surface workstation.

In other aspects, embodiments disclosed herein relate to a method of providing an image of a wellbore, the method including providing a downhole imaging tool and a surface workstation having real-time data communication therebetween, inserting the downhole imaging tool in the wellbore and lowering the downhole imaging tool to a specified location of the wellbore, capturing and transferring image data of the specified location of the wellbore through the real-time data communication to the surface workstation, and constructing an image of the specified location of the wellbore on the surface workstation.

Other aspects and advantages of the invention will be apparent from the following description and the appended claims.

### BRIEF DESCRIPTION OF DRAWINGS

FIG. 1 is a representative view of a downhole imaging system in accordance with one or more embodiments of the present disclosure.

FIG. 2 is a perspective view of a downhole imaging tool in accordance with one or more embodiments of the present disclosure.

FIG. 3 is a cross-section view of a downhole imaging tool in accordance with one or more embodiments of the present disclosure.

FIG. 4 is a flowchart of methods of using a downhole imaging system in accordance with one or more embodiments of the present disclosure.

### DETAILED DESCRIPTION

In one aspect, embodiments disclosed herein relate to a downhole imaging system and related methods of using the downhole imaging system to locate and construct images of a specific wellbore location and provide the images to the surface for use by an operator. For example, certain anomalies may be present in the wellbore for which an image of the anomaly may be beneficial, including, but not limited to, cracks, corrosion, scale, a collapsed diameter of a section of casing, casing out-of-roundness, milled windows, and other unwanted objects present in the wellbore. Embodiments disclosed herein provide a tool and methods of constructing an image of such anomalies.

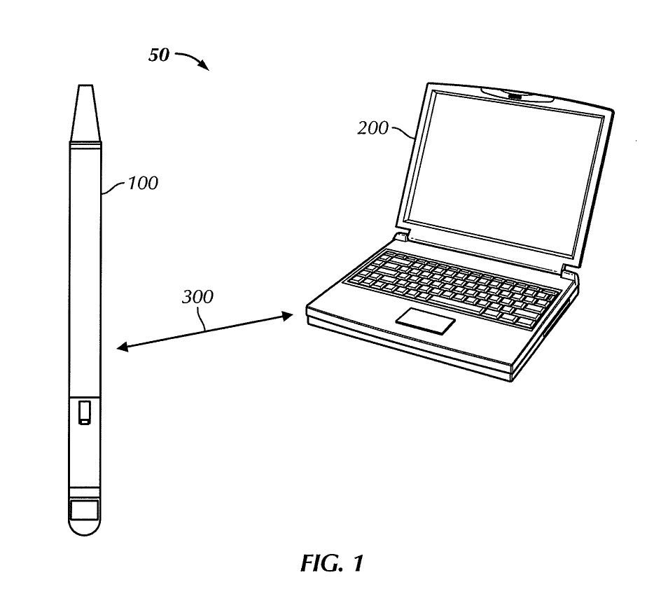

Referring to FIG. 1, a representative view of a downhole imaging system 50 in accordance with one or more embodiments of the present disclosure is shown. Downhole imaging system 50 includes three subsystems, namely a downhole imaging tool 100, a surface workstation 200, and a connection 300 therebetween. The surface workstation 200 may include a workstation computer and a surface power supply and communications interface. Connection 300 may include a multi conductor cable or fiber optic cable configured to link the downhole imaging tool 100 with the surface workstation 200 to provide an optimum frequency response with high data rate and large quantity of data transfer therebetween. Connection 300 may be configured to provide real time or instantaneous communication between the downhole imaging tool 100 and the surface workstation 200 (e.g., at least 500 kbaud per second). In alternate embodiments, connection 300 may be a wireless connection.

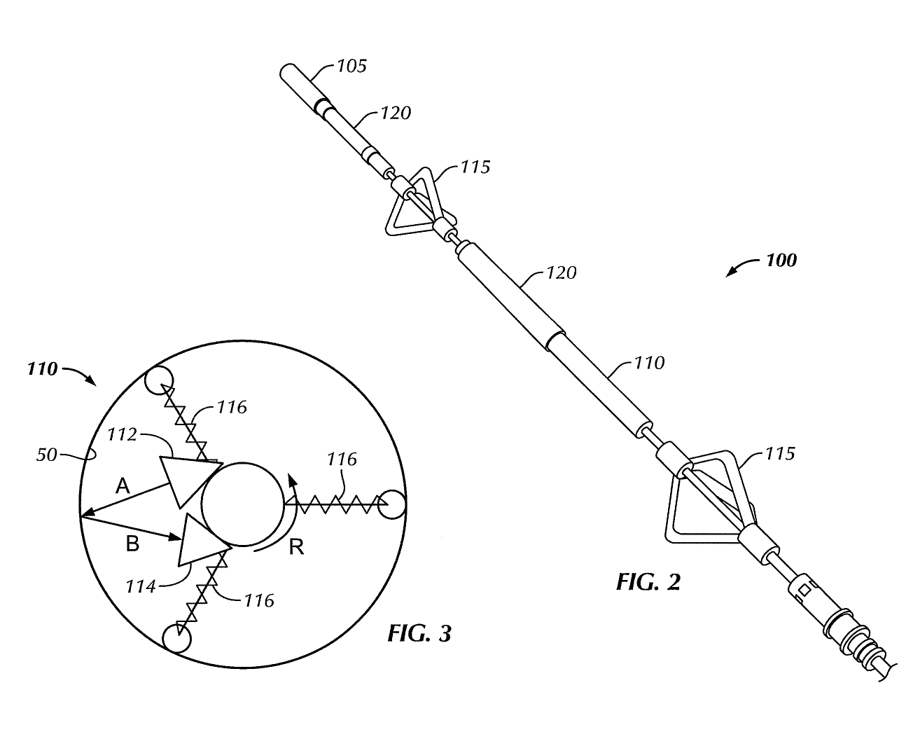

Referring now to FIG. 2, a perspective view of the downhole imaging tool 100 in accordance with one or more embodiments of the present disclosure is shown. Downhole imaging tool 100 may be disposed at a distal end of a cable or wireline (not shown). Downhole imaging tool 100 may include one or more stabilizers 115 configured to extend and secure the downhole imaging tool 100 within a wellbore at a particular location. Further, downhole imaging tool 100 includes a first probe 105 and a second probe 110 along with electronics 120, which is configured to provide power and communication to the probes 105 and 110, respectively.

The first probe 105, which may also be characterized as a collision avoidance probe (“CAP”), may be disposed at a distal end of the downhole imaging tool 100. The CAP 105 may be configured to “see” anomalies as the CAP 105 approaches them downhole. Stated otherwise, the CAP 105 is configured to sense an approaching anomaly to indicate to an operator that the anomaly is near and allow the operator to slow deployment of the downhole imaging tool 100. Once the downhole imaging tool 100 is deployed to the anomaly location, the stabilizers 115 may be used to secure the downhole imaging tool 100 in the wellbore. The second downhole probe 110 is configured to construct an image of the anomaly in the wellbore, using ultrasound technology to inspect the wellbore or casing.

Referring now to FIG. 3, a cross-section view of a downhole probe 110 in accordance with one or more embodiments of the present disclosure is shown. The downhole probe 110 may include an emitter 112 located at a center of the imaging tool that points towards the inner wall 50 of a casing or wellbore. In certain embodiments, acoustic waves located in a frequency range of between 0.5 MHz and 15 MHz and a wavelength range of between 0.10 mm and 3 mm are configured to be emitted from the downhole probe 110. The downhole probe 110 further includes a receiver 114 configured to pick up a signal reflected by the inner wall 50. Waves “A” originate at the emitter 112 and travel through a medium inside the wellbore (e.g., air, water, mud, oil) toward the inner wall 50. The intensity of reflected waves “B” may depend on characteristics and/or orientation of the inner wall at that particular point and the integrity of the inner wall. For instance, should a leak exist at that location, reflected waves B would differ significantly compared to reflected waves from a defect free area (e.g., more echoes and delays may be measured if the surface has a defect or leak), thus indicating the presence of the leak to the operator.

Positioning of the emitter 112 and receiver 114 may be adjusted and controlled with mechanical stabilizers 116. There may only be one pair of emitter-receiver 112, 114, thus, both components may be rotated “R” to perform a complete scan of a circumferential section of the inner wall 50. A complete length of the wellbore may inspected by moving the downhole probe 110 along a longitudinal axis of the wellbore (i.e., up and down the wellbore). In alternate embodiments, rather than rotating the emitter-receiver combination, more than one pair of emitter-receivers may be used with each pair pointing at different parts of the pipe with an overlap therebetween (not shown). In addition, a forward-looking (i.e., down the wellbore) inspection may be achieved using another emitter-receiver pair pointing along the longitudinal axis of the wellbore (i.e., down the wellbore).

In certain embodiments, the downhole probe 110 may work in a pulse-echo mode. In pulse-echo mode, a series or train of pulses (e.g., from 4 to 32 pulses) may be generated from the emitter 112. In one example, the duration of this train or pulses may be in the order of 4 μs as for a 16 4-MHz-frequency pulse train. The train of pulses may be scattered, reflected, and/or dispersed by the reflective sample, in this case the inner wall 50 of the wellbore. Typically, a main pulse may be generated followed by several echoes or smaller pulses. By measuring the spectral and timing characteristics of the returned signal and delays with respect to the original train of pulses, it may be possible to measure scattering and/or reflection properties of the inner wall 50 of the wellbore. In certain alternate embodiments, a single device may be used both as emitter and receiver (rather than a separate emitter and receiver). In the case of a single device, a cooling period after the train of pulses is generated may be implemented to allow the device to cool down in order to reduce thermal noise while acquiring the returning signal. The duration of the cooling period is typically similar to the period of fewest pulses.

In certain embodiments, the downhole imaging tool 100 may be an Acoustic Camera™ available from Sonasearch, Inc., located in Redmond, Wash. The downhole imaging tool 100 may have the ability to accurately ensonify boreholes of between 3½ inches and 13⅜ inches diameter through either water or through turbid medium such as drilling mud. The downhole imaging tool 100 may also be configured to provide 360 degree circumferential coverage of the wellbore or casing wall and a 180 degree sweeping coverage (i.e., a 180 degree downhole looking sweep with respect to a central longitudinal wellbore axis). Further, the downhole imaging tool 100 may be rated to withstand downhole pressure of between 12,000 psi and 20,000 psi and downhole temperatures of at least 150 degree Celsius (300 degrees Fahrenheit). Images provided by the downhole imaging tool may have at least 10 mm lateral resolution and at least 100 mm depth resolution.

Deployment of the downhole imaging system may be commenced by running the downhole imaging tool into the wellbore at a standard feed rate on a wireline. As the downhole imaging tool is lowered and nears an object in the wellbore, the operator may begin to see a fuzzy overview on the surface workstation of the object in the wellbore when the downhole tool is approximately 15-20 feet above the object, which signals to the operator that the object is near. Deployment of the downhole imaging tool on the wireline may be slowed until the downhole imaging tool is positioned approximately 6 inches to 1 foot above the object. The downhole imaging tool may then be oriented and stabilized in the wellbore to steady the tool for downhole image construction (i.e., emitting/receiving ultrasound waves).

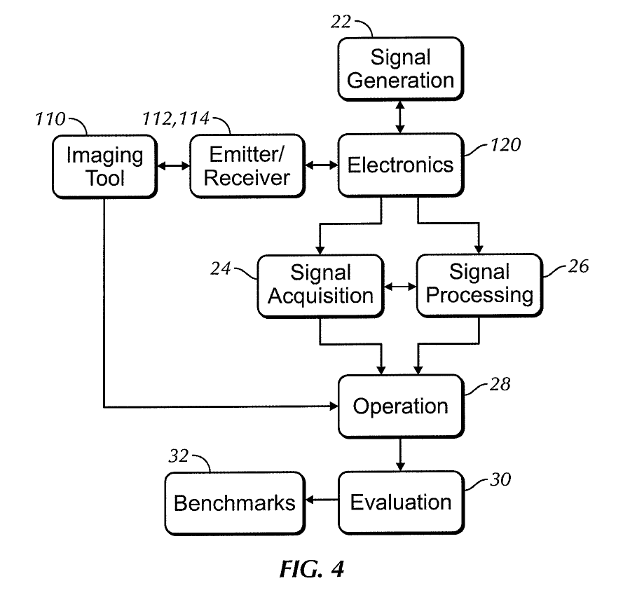

Referring now to FIG. 4, a flowchart illustrating methods associated with using the downhole imaging system in accordance with one or more embodiments of the present disclosure is shown. As shown in the flowchart, the downhole imaging tool 110 includes an internal emitter 112 and receiver 114 (collectively a transducer) and electronics 120 to control the transducer. Initially, signal generation 22, in which ultrasound waves are generated, is commenced as the ultrasound waves are emitted. The ultrasound waves are emitted toward an inner wall of the wellbore and reflected back to the receiver 114 during signal acquisition 24 and signal processing 26 steps. From the signal acquisition 24 and signal processing 26 steps, the received signals are evaluated 30 for comparison to previously collected signals or benchmarks 32, which may indicate changes (i.e., the anomaly) in the wellbore.

Advantageously, embodiments of the present disclosure for a downhole imaging system provide improved inspection methods allowing the operator to initiate remedial actions that minimizes or eliminates potential workover expenditures. The downhole tool may be used as a proactive diagnostic tool to establish the general condition of downhole tubing and casing and allow subsequent preventative maintenance inspection to be used to monitor any progressive deterioration and remedial work to be planned. Further, the downhole imaging system is capable of providing downhole images of a wellbore to an operator at precise locations in the wellbore. Thus, the downhole imaging system allows an operator to have a clearer picture of specifics of a particular location of the wellbore prior to attempts to retrieve a stuck downhole tool or other downhole operations. In addition, the downhole imaging system is capable of providing downhole images regardless of murky downhole fluids that exist in the wellbore. Overall, the downhole imaging system may reduce costs of retrieving objects from the wellbore and/or sidetracking costs by allowing an operator have a clear picture of the specific downhole location and perform the downhole operation correctly the first time.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A downhole imaging system comprising:
a downhole imaging tool;
a surface workstation; and
a real-time data feed configured to connect between the downhole imaging tool and the surface workstation.

2. The downhole imaging system of claim 1, further comprising a collision avoidance probe disposed at a distal end of the downhole imaging tool.

3. The downhole imaging system of claim 1, wherein the downhole imaging tool is configured to provide 360 degree circumferential profiling of an internal surface of a wellbore.

4. The downhole imaging system of claim 1, wherein the downhole imaging tool is configured to provide 180 degree downhole sweeping imaging of a wellbore.

5. The downhole imaging system of claim 1, wherein the downhole imaging tool is configured to ensonify a wellbore diameter between about 3½ inch and about 13⅜ inch.

6. The downhole imaging system of claim 1, wherein the umbilical is configured to provide image data from the downhole imaging tool to the surface workstation at data rate of at least 500 kbaud per second.

7. The downhole imaging system of claim 1, wherein the downhole imaging tool is configured to withstand downhole temperatures of at least 150 degrees Celsius.

8. The downhole imaging system of claim 1, wherein the downhole imaging tool is configured to withstand a downhole pressure of up to 20,000 psi.

9. The downhole imaging system of claim 1, wherein the downhole imaging tool is configured to provide images having at least 10 mm lateral resolution.

10. The downhole imaging system of claim 1, wherein the downhole imaging tool is configured to provide images having at least 100 mm depth resolution.

11. The downhole imaging system of claim 1, wherein acoustic waves located in a frequency range of between 0.5 MHz and 15 MHz and a wavelength range of between 0.10 mm and 3 mm are configured to be emitted from the downhole imaging tool.

12. The downhole imaging system of claim 1, wherein the real-time data feed is a wireless connection.

13. A method of providing an image of a wellbore, the method comprising:
providing a downhole imaging tool and a surface workstation having real-time data communication therebetween;
inserting the downhole imaging tool in the wellbore and lowering the downhole imaging tool to a specified location of the wellbore;
capturing and transferring image data of the specified location of the wellbore through the real-time data communication to the surface workstation; and
constructing an image of the specified location, of the wellbore on the surface workstation.

14. The method of claim 13, further comprising providing a 360 degree circumferential image construction of the wellbore.

15. The method of claim 13, further comprising providing a 180 degree downhole sweeping image construction of the wellbore.

16. The method of claim 13, further comprising providing a downhole image having at least 10 mm lateral resolution.

17. The method of claim 13, further comprising providing a downhole image having at least 100 mm depth resolution.

18. The method of claim 13, further comprising providing captured image data at data rate of at least 500 kbaud per second to the surface workstation.

19. The method of claim 13, further comprising providing real-time data communication wirelessly between the downhole imaging tool and the surface workstation.

20. The method of claim 13, further comprising providing a collision avoidance probe to sense nearby objects in the wellbore.
